(19) United States
(12) Patent Application Publication
(10) Pub. No.: US 2021/0301571 A1
(43) Pub. Date: Sep. 30, 2021

(54) Folding Mechanism

(71) Applicant: Fuzhou Leisiao Information Technology Co., Ltd., Fuzhou (CN)

(72) Inventor: Zhiqiang Xie, Fuzhou (CN)

(21) Appl. No.: 16/860,048

(22) Filed: Apr. 27, 2020

(30) Foreign Application Priority Data
Mar. 30, 2020 (CN) 202020429379.9

(51) Int. Cl. E05D 11/10; B62K 15/00

(52) U.S. Cl. CPC E05D 11/1014; B62K 2015/001; B62K 15/006

(57) ABSTRACT

A folding mechanism comprises a first folding body, a second folding body and a first clamping piece, the second folding body is provided with a second clamping piece, and the first folding body connected to the first clamping piece; and when the first folding body and the second folding body are unfolded, abutting parts of the first clamping piece are clamped in the second clamping piece, and a gap is formed between a non-abutting part of the first clamping piece and the second folding body. The first clamping piece connected to the first folding body is clamped in the second clamping piece on the second folding body to fix the first folding body and the second folding body when the first folding body and the second folding body are unfolded, and the gap is reserved to avoid shakes.

### CROSS REFERENCE TO RELATED APPLICATIONS

The present application claims the benefit of Chinese Patent Application No. 202020429379.9 filed on Mar. 30, 2020, the contents of which are incorporated herein by reference in their entirety.

### TECHNICAL FIELD

The invention relates to the technical field of folding, in particular to a folding mechanism.

### DESCRIPTION OF RELATED ART

Many existing facilities need to be compressed in space by means of folding mechanisms. For example, electrical scooters are typically equipped with a detachable and foldable saddle, thereby being lighter and simpler in structure than traditional electrical bicycles and capable of saving a great quantity of social resources and having gained extensive attention from urban users. Wherein, the foldable electrical scooters are designed in such a manner that a folding mechanism is arranged between a frame and a vertical bar to allow the vertical bar to be folded on the frame.

However, the folding mechanism of existing electrical scooters is complicated and poor in practicability.

### BRIEF SUMMARY OF THE INVENTION

The technical issue to be settled by the invention is to provide a folding mechanism which is simple in structure and high in practicability and durability.

The technical solution adopted by the invention to settle the aforementioned technical issue is as follows:

A folding mechanism comprises a first folding body, a second folding body and a first clamping piece, wherein the first folding body is rotatably connected to the second folding body, the second folding body is provided with a second clamping piece, and the first folding body is connected to the first clamping piece; and

When the first folding body and the second folding body are unfolded, abutting parts of the first clamping piece are clamped in the second clamping piece, and a gap is formed between a non-abutting part of the first clamping piece and the second folding body.

Furthermore, the second clamping piece is a second clamping groove, the first folding body is formed with a first clamping groove, and the first clamping piece is a U-shaped clamping piece which has one end clamped in the first clamping groove and the other end clamped in the second clamping groove; and

The two ends of the U-shaped clamping piece are the abutting parts, and a bottom side, towards the second folding body, of the U-shaped clamping piece is the non-abutting part.

Furthermore, the folding mechanism further comprises a screw rod and a knob, and the first folding body has a connecting part; and

The screw rod has one end connected to the connecting part in a threaded manner and the other penetrating through the U-shaped clamping piece to be fixedly connected to the knob

Furthermore, the folding mechanism further comprises a screw rod and a knob, and the first folding body has a connecting part; and

The screw rod has one end fixedly connected to the connecting part and the other end penetrating through the U-shaped clamping piece to be connected to the knob in a threaded manner.

Furthermore, an elastic gasket is arranged between the knob and the U-shaped clamping piece.

Furthermore, inner sides of the two ends of the U-shaped clamping piece gradually expand outwards towards an opening of the U-shaped clamping piece, the first clamping groove has a first oblique plane, the second clamping groove has a second oblique plane, the inner side of one end of the U-shaped clamping groove is attached to the first oblique plane, and the inner side of the other end of the U-shaped clamping piece is attached to the second oblique plane.

Furthermore, the first clamping groove and the second clamping groove are axially symmetric with each other when the first folding body and the second folding body are unfolded, the screw rod and the connecting part are located between the first clamping groove and the second clamping groove, and the screw rod penetrates through the center of the U-shaped clamping piece to be connected to the center of the knob.

Furthermore, a U-shaped folding surface towards the U-shaped clamping piece is formed when the first folding body and the second folding body are unfolded; and

A gap is formed between the bottom side of the U-shaped clamping piece and the folding surface when the first folding body and the second folding body are unfolded.

Furthermore, a limit ring is arranged on the screw rod, and the U-shaped clamping piece has a fixing hole allowing the screw rod to penetrate through; and

The outer diameter of the limit ring is greater than the diameter of the fixing hole, and the U-shaped clamping piece is clamped between the limit ring and the knob.

Furthermore, the first folding body is a folding saddle locked on a frame of an electrical scooter with a bolt, the second folding body is a folding cover fixed to a vertical bar of the electrical scooter, and the folding saddle and the folding cover rotate upwards or downwards by means of a folding pin to form a hinge structure.

The invention has the following beneficial effects: the first folding body and the second folding body are rotatably connected to fulfill folding; the first clamping piece connected to the first folding body is clamped in the second clamping piece on the second folding body to fix the first folding body and the second folding body when the first folding body and the second folding body are unfolded; meanwhile, when the abutting parts, clamped in the second clamping piece, of the first clamping piece are worn, the first clamping piece can be further clamped in the second clamping piece via the gap between the non-abutting part of the first clamping piece and the second folding body, so that shakes caused by wear, deformation or looseness of the abutting parts are avoided; and the folding mechanism of the invention can be folded and unfolded with a few parts and is high in practicability and durability.

### BRIEF DESCRIPTION OF THE SEVERAL VIEWS OF THE DRAWINGS

FIG. 1 is perspective view of a folding mechanism in an embodiment of the invention;

FIG. 2 is a disassembled diagram of the folding mechanism in the embodiment of the invention;

FIG. 3 is a front view of the folding mechanism in the embodiment of the invention;

FIG. 4 is an A-A sectional view of FIG. 3;

FIG. 5 is an enlarged view of part A in FIG. 4;

### REFERENCE SIGNS

1, first folding body; 2, second folding body; 3, U-shaped clamping piece; 4, second clamping groove; 5, screw rod; 6, knob; 7, elastic gasket; 8, folding pin; 9, gap; 11, connecting part; 12, folding surface; 13, first clamping groove; 14, first oblique plane; 31, clamping piece end; 32, clamping piece bottom; 33, inner side; 34, opening; 35, bottom side; 36, fixing hole; 41, second oblique plane; 51, limit ring.

### DETAILED DESCRIPTION OF THE INVENTION

The technical contents, objectives and effects of the invention are expounded below in conjunction with the embodiments and accompanying drawings.

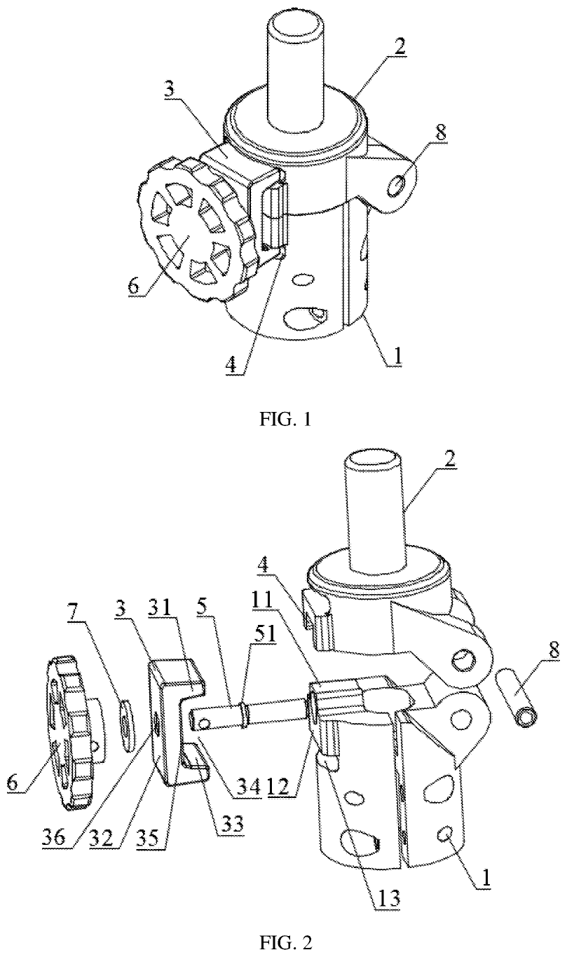

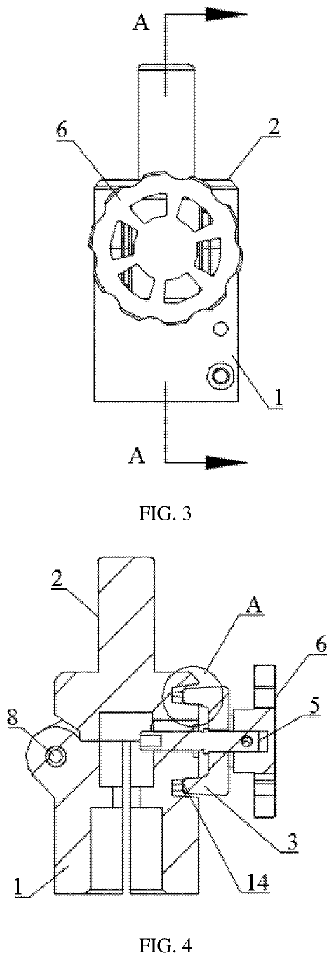

Referring to FIG. 1 to FIG. 5, a folding mechanism comprises a first folding body, a second folding body and a first clamping piece, wherein the first folding body is rotatably connected to the second folding body, the second folding body is provided with a second clamping piece, and the first folding body is connected to the first clamping piece;

When the first folding body and the second folding body are unfolded, abutting parts of the first clamping piece are clamped in the second clamping piece, and a gap is formed between a non-abutting part of the first clamping piece and the second folding body.

From the above description, the invention has the following beneficial effects: the first folding body and the second folding body are rotatably connected to fulfill folding; the first clamping piece connected to the first folding body is clamped in the second clamping piece on the second folding body to fix the first folding body and the second folding body when the first folding body and the second folding body are unfolded; meanwhile, when the abutting parts, clamped on the second clamping piece, of the first clamping piece are worn, the first clamping piece can be further clamped in the second clamping piece via the gap between the non-abutting part of the first clamping piece and the second folding body, so that shakes caused by wear, deformation or looseness of the abutting parts is avoided; and the folding mechanism of the invention can be folded and unfolded with a few parts and is high in practicability and durability.

Furthermore, the second clamping piece is a second clamping groove, the first folding body is formed with a first clamping groove, the first clamping piece is a U-shaped clamping piece, one end of the U-shaped clamping piece is clamped in the first clamping groove, and the other end of the U-shaped clamping piece is clamped in the second clamping groove;

The two ends of the U-shaped clamping piece are the abutting parts, and a bottom side, towards the second folding body, of the U-shaped clamping piece is the non-abutting part.

From the above description, the U-shaped clamping piece is clamped in the clamping grooves in the two folding bodies, and when the abutting parts at the two ends of the U-shaped clamping piece are worn, the abutting parts can be further clamped in the clamping grooves by means of the gap reserved between the bottom side in the middle and the second folding body to maintain the clamping condition.

Furthermore, the folding mechanism further comprises a screw rod and a knob, and the first folding body has a connecting part;

One end of the screw rod is connected to the connecting part in a threaded manner, and the other end of the screw rod penetrates through the U-shaped clamping piece to be fixedly connected to the knob.

From the above description, the U-shaped clamping piece is located between the knob and the connecting part, wherein when the first folding body and the second folding body are unfolded, that is, the first folding body and the second folding body rotate until the planes thereof abut against each other, a user screws the screw rod into the connecting part by means of the knob to squeeze the U-shaped clamping piece to move towards the clamping grooves until the two ends of the U-shaped clamping piece are separately clamped in the corresponding clamping grooves; and by adoption of surface contact and threaded locking, the whole folding mechanism has high assembly strength, and the stability and safety are guaranteed when the first folding body and the second folding body are unfolded.

Furthermore, the folding mechanism further comprises a screw rod and a knob, and the first folding body has a connecting part;

One end of the screw rod is fixedly connected to the connecting part, and the other end of the screw rod penetrates through the U-shaped piece to be connected to the knob in a threaded manner.

From the above description, the screw rod is fixedly connected to the connecting part and is connected to the knob in the threaded manner, so that when screwed along the screw rod, the knob can squeeze the U-shaped clamping piece to move towards the first clamping groove and the second clamping groove until the two ends of the U-shaped clamping piece are respectively clamped in the corresponding clamping grooves.

Furthermore, an elastic gasket is arranged between the knob and the U-shaped clamping piece.

From the above description, the elastic gasket is arranged to fulfill an anti-loose effect, so that the knob will not come loose when the folding mechanism is used in a complicated application scenario.

Furthermore, inner sides of the two ends of the U-shaped clamping piece gradually expand outwards towards an opening of the U-shaped clamping piece, the first clamping groove has a first oblique plane, the second clamping groove has a second oblique plane, the inner side of one end of the U-shaped clamping piece is attached to the first plane, and the inner side of the other end of the U-shaped clamping piece is attached to the second oblique plane.

From the above description, the inner sides of the two ends of the U-shaped clamping piece gradually expand outwards (namely, expand towards the outside) towards the opening of the U-shaped clamping piece, that is, the inner sides of the two ends of the U-shaped clamping piece are also oblique planes, and the opening of the U-shaped clamping piece is gradually enlarged outwards, so that the U-shaped clamping piece can be inserted into the corresponding clamping grooves to make sure that the oblique planes at the two ends of the U-shaped clamping piece are cooperatively connected to the first oblique plane of the first clamping groove and the second oblique plane of the second clamping grooves, respectively; and meanwhile, the contact areas between the oblique planes are larger, thus guaranteeing the connection stability of the first folding body and the second folding body in an unfolded state.

Furthermore, the first clamping groove and the second clamping groove are axially symmetric with each other when the folding body and the second folding body are unfolded, the screw rod and the connecting part are located between the first clamping groove and the second clamping groove, and the screw rod penetrates through the center of the U-shaped clamping piece to be connected to the center of the knob.

From the above description, the whole clamping assembly is axially symmetric in an unfolded state, thus guaranteeing a uniform clamping force.

Furthermore, a folding surface towards the U-shaped clamping piece is formed when the first folding body and the second folding body are unfolded;

A gap is formed between the bottom side of the U-shaped clamping piece and the folding surface when the first folding body and the second folding body are unfolded.

From the above description, the gap is reserved between the bottom side of the U-shaped clamping piece and the folding surface on the connecting part, so that when the abutting face of the first clamping groove, the second clamping groove or the U-shaped piece is worn, the U-shaped clamping piece can be further screwed to be locked in the corresponding clamping grooves, thus avoiding shakes caused by wear, deformation or looseness of the abutting parts. The folding mechanism is high in practicability and durability.

Furthermore, a limit ring is arranged on the screw rod, and the U-shaped clamping piece has a fixing hole allowing the screw rod to penetrate through;

The outer diameter of the limit ring is greater than the diameter of the fixing hole, and the U-shaped clamping piece is clamped between the limit ring and the knob.

From the above description, the U-shaped clamping piece can also be fixed between the limit ring and the knob when the first folding body and the second folding body are folded, thus being prevented from accidentally sliding on the screw rod.

Furthermore, the first folding body is a folding saddle locked on a frame of an electrical scooter with a bolt, the second folding body is a folding cover fixed to a vertical bar of the electrical scooter, and the folding saddle and folding cover rotate upwards or downwards by means of a folding pin to form a hinge structure.

From the above description, the folding mechanism is applied to the electrical scooter to realize folding of the vertical bar and the frame of the electrical scooter; and meanwhile, compared with existing folding mechanisms of electrical scooters, the folding mechanism has a few parts and a simple structure, and is high in part strength, easy to fold and high in practicability.

The folding mechanism of the invention can be applied to an electrical scooter or a folding bicycle and is explained below in conjunction with the specific application scenario.

Referring to FIG. 1 to FIG. 5, Embodiment 1 of the invention is expounded below:

In this embodiment, the folding mechanism is applied to an electrical scooter. Thus, the first folding body 1 shown in FIG. 1 to FIG. 5 can also be referred to as a folding saddle which is locked on a frame of the electrical scooter with bolts, the second folding body 2 can also be referred to as a folding cover which is fixed to a vertical bar of the electrical scooter, and the folding saddle and the folding cover rotate upwards or downwards by means of a folding pin 8 to form a hinge structure. The folding mechanism in this embodiment is specifically as follows:

A folding mechanism comprises a first folding body 1, a second folding body 2 and a first clamping piece, wherein the first folding body 1 is rotatably connected to the second folding body 2 through a folding pin 8, a second clamping piece is arranged on the second folding body 2, and the first folding body 1 is connected to the first clamping piece; and when the first folding body 1 and the second folding body 2 are unfolded, abutting parts of the first clamping piece are clamped in the second clamping piece, and a gap is formed between a non-abutting part of the first clamping piece and the second folding body.

Wherein, in the case where the folding mechanism in this embodiment is applied to the electrical scooter, when the first folding body 1 and the second folding body 2 are unfolded, the vertical bar is unfolded on the frame, so that the whole electrical scooter is in a serviceable condition; at this moment, the first clamping piece is clamped in the second clamping piece to fix the first folding body 1 and the second folding body 2, and the vertical bar and the frame are fixed, accordingly. When the electrical scooter is not used, the first clamping piece and the second clamping piece are released to allow the vertical bar to rotate onto the frame along with the second folding body 2, so that the whole electrical scooter is folded. Therefore, compared with existing folding mechanisms of electrical scooters, the folding mechanism in this embodiment has a few parts and is simple and practical in structure.

Considering that the existing folding mechanisms may be worn or deformed or come loose after being used for a period of time and hence may shake when folded, the gap is reserved between the non-abutting part of the first clamping piece and the second folding body in this invention, that is, a space is reserved to allow the first clamping piece to be further clamped in the second clamping piece to be kept in the clamped state, so that shakes will not be caused even if the abutting parts are worn or deformed or come loose.

Referring to FIG. 1 to FIG. 5, Embodiment 2 of the invention is expounded below:

In this embodiment, the folding mechanism is applied to the electrical scooter. On the basis of Embodiment 1, the folding mechanism in this embodiment is specifically as follows:

With regard to the folding mechanism in this embodiment, the first clamping piece is a U-shaped clamping piece 3, the second clamping piece is a second clamping groove 4, and the first folding body 1 is formed with a first clamping groove 13; and one end of the U-shaped clamping piece 3 is clamped in the first clamping groove 13, and the other end of the U-shaped clamping piece 3 is clamped in the second clamping groove 4, as shown in FIG. 2.

On this basis, to ensure that the U-shaped clamping piece 3 is always clamped in the first clamping groove 13 and the second clamping groove 4, the whole folding mechanism further comprises a screw rod 5 and a knob 6, and the first folding body 1 has a connecting part 11, wherein one end of the screw rod 5 is connected to the connecting part 11 in a threaded manner, and the other end of the screw rod 5 penetrates through the U-shaped clamping piece 3 to be fixedly connected to the knob 6. In this way, when the knob 6 is screwed along the screw rod 5, the U-shaped clamping piece 3 will be squeezed to move towards the first clamping groove 13 and the second clamping groove 4 until the two ends of the U-shaped clamping piece 3 are respectively clamped in the first clamping groove 13 and the second clamping groove 4; at this moment, the screw rod 5 and the connecting part 11 will be kept in threaded connection in the absence of an external force, so that the two ends of the U-shaped clamping piece 3 will be always clamped in the first clamping groove 13 and the second clamping groove 4, and the vertical bar and the frame are kept in the serviceable condition. In other equivalent embodiments, the screw rod 5 is connected to the connecting part 11 and the knob 6 as follows, as a substitution: one end of the screw rod 5 is fixedly connected to the connecting part 11, and the other end of the screw rod 5 penetrates through the U-shaped clamping piece 3 to be connected to the knob 6 in a threaded manner; and in this case, the screw rod 5 is fixedly connected to the connecting part 11, and the knob 6 needs to be screwed on the screw rod 5 to squeeze the two ends of the U-shaped clamping piece 3 to be respectively clamped in the first clamping groove 13 and the second clamping groove 4. It can thus be seen that in other equivalent embodiments, the two ends of the U-shaped clamping piece 3 can be clamped in the first clamping groove 13 and the second clamping groove 4 in other locking and limiting manners.

As shown in FIG. 2, an elastic gasket 7 is arranged between the knob 6 and the U-shaped clamping piece 3 to prevent the knob 6 from getting loose, wherein the elastic gasket 7 is a rubber gasket in this embodiment and can be any other elastic sheets such as wavy gaskets in other embodiments. In the case where the folding mechanism is applied to the electrical scooter, the elastic gasket can prevent the knob 6 from getting loose even if the electrical scooter vibrates and bumps when being ridden under a complicated road condition for a long time.

As shown in FIG. 2, a limit ring 51 is arranged on the screw rod 5 to limit the relative displacement of the U-shaped clamping piece 3, and the outer diameter of the limit ring 51 is greater than the diameter of a fixing hole 36, which is formed in the U-shaped clamping piece 3 to allow the screw rod 5 to penetrate through, so that the U-shaped clamping piece 3 is clamped between the limit ring 51 and the knob 6.

As shown in FIG. 4, the whole folding mechanism is further limited in position as follows: the first clamping groove 13 and the second clamping groove 4 are axially symmetric with each other when the first folding body 1 and the second folding body 2 are unfolded, the screw rod 5 and the connecting part 11 are both located between the first clamping groove 13 and the second clamping groove 4, and the screw rod 5 penetrates through the center of the U-shaped clamping piece to be connected to the center of the knob 6, that is, the whole folding mechanism is axially symmetric at the folding position.

From the above description, in the case where the folding mechanism in this embodiment is applied to the electrical scooter, when the first folding body 1 and the second folding body 2 are unfolded, the vertical bar is unfolded on the frame, so that the whole electrical scooter will be in a serviceable condition; and at this moment, the first folding body 1 and the second folding body 2 are folded, and the U-shaped clamping piece 3 is clamped in the first clamping groove 13 and the second clamping groove 4 by means of the knob 6. When the electrical scooter is not used, the U-shaped clamping piece 3 is unscrewed from the first clamping groove 13 and the second clamping groove 4 by means of the knob 6, and the vertical rod rotates onto the frame along with the second folding body 2, so that the whole electrical scooter is folded. Therefore, compared with existing folding mechanisms of electrical scooters, the folding mechanism in this embodiment has a few parts, is simple and practical in structure and better in connection stability and safety, and can prevent the knob 6 from getting loose.

Referring to FIG. 1 to FIG. 5, Embodiment 3 of the invention is expounded below:

In this embodiment, the folding mechanism is applied to the electrical scooter. On the basis of Embodiment 2, the folding mechanism in this embodiment is particularly as follows:

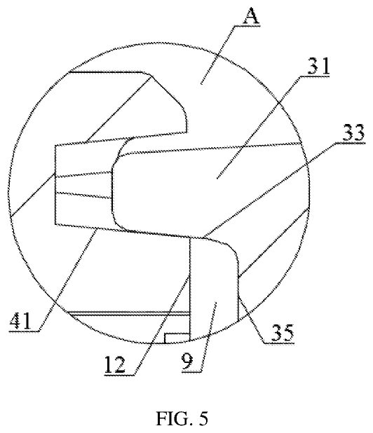

With regard to the folding mechanism in this embodiment, the U-shaped clamping piece 3 has clamping piece ends 31 at the two ends of the U-shaped clamping piece 3, a clamping piece bottom 32 at the bottom of the U-shaped clamping piece 3, inner sides 33 on the inner sides of the clamping piece ends 31, an opening 34 between the two clamping piece ends 31, and a bottom side 35 on the inner side of the clamping piece bottom 32, as shown in FIG. 2 and FIG. 5.

In this embodiment, as shown in FIG. 5, the inner sides 33 at the two clamping piece ends 31 gradually expand towards the opening 34 of the U-shaped clamping piece 3, that is, the two inner sides 33 are oblique planes and the distance between the two inner sides 33 is gradually increased outwards. Correspondingly, the first clamping groove 13 has a first oblique plane 14, the second clamping groove 4 has a second oblique plane 41, the inner side 33 at one end of the U-shaped clamping piece 3 is attached to the first oblique plane 14, and the inner side 33 at the other end of the U-shaped clamping piece 3 is attached to the second oblique plane 41, that is, the first clamping groove 13 and the second clamping groove 4 are both beveled grooves. In this case, the oblique inner sides 33 at the clamping piece ends 31 are cooperatively pressed against the first oblique plane 14 of the first clamping groove 13 and the second oblique plane 41 of the second clamping groove 4 respectively.

As shown in FIG. 5, when the first folding body 1 and the second folding body 2 are unfolded, a folding surface 12 towards the U-shaped clamping piece 3 is formed. In FIG. 5, the folding surface 12 is a vertical plane; and in this case, a gap 9 is formed between the bottom side 35 of the U-shaped clamping piece 3 and the folding surface 12 when the first folding body 1 and the second folding body 2 are unfolded, and when an abutting face of the first clamping groove 13, the second clamping groove 4 or the U-shaped clamping piece 3 is worn, the U-shaped clamping piece 3 can be further screwed into the first clamping groove 13 and the second clamping groove 4 to be locked via the gap 9.

In other equivalent embodiments, the surfaces, towards the U-shaped clamping piece 3, of the first folding body 1 and the second folding body 2 may not be located on the same plane when the first folding body and the second folding body 2 are unfolded, and only the gap 9 between the folding surface 12 and the bottom side 35 of the U-shaped clamping piece 3 is reserved.

In addition, in this embodiment, the gap between the bottom side 35 of the U-shaped clamping piece 3 and the folding surface 12 is 1-3 mm, such as 1 mm, 2 mm or 3 mm.

In summary, according to the folding mechanism of the invention, the knob is screwed along the screw rod to squeeze the U-shaped clamping piece to move towards the first clamping groove and the second clamping groove until the two ends of the U-shaped clamping piece are separately clamped in the corresponding clamping grooves, so that folding and unfolding of the two folding bodies are realized; the elastic gasket is arranged to fulfill an anti-loose effect; the oblique planes are designed to facilitate clamping and to increase the contact area; and the gap is reserved between the bottom side of the U-shaped clamping piece and the folding surface on the connecting part to prevent shakes caused by wear, deformation or looseness of the abutting parts. Therefore, the folding mechanism of this application has the advantages of having a few parts and being simple in structure, high in part strength, not prone to looseness or deformation, easy to fold, high in practicability and durability, and more stable and reliable in structure.

The aforesaid description is only used to explain the embodiments of the utility mode, and is not intended to limit the patent scope of the invention. All equivalent transformations achieved according to the contents of the specification and accompanying drawings of the utility mode, or direct or indirect applications to relating technical fields should also fall within the patent protection scope of the invention.

What is claimed is:

1. A folding mechanism, comprising a first folding body, a second folding body and a first clamping piece, wherein the first folding body is rotatably connected to the second folding body, the second folding body is provided with a second clamping piece, and the first folding body is connected to the first clamping piece; and
when the first folding body and the second folding body are unfolded, abutting parts of the first clamping piece are clamped in the second clamping piece, and a gap is formed between a non-abutting part of the first clamping piece and the second folding body.

2. The folding mechanism according to claim 1, wherein the second clamping piece is a second clamping groove, the first folding body is formed with a first clamping groove, and the first clamping piece is a U-shaped clamping piece which an end clamped in the first clamping groove and an end clamped in the second clamping groove; and
the two ends of the U-shaped clamping piece are the abutting parts, and a bottom side, towards the second folding body, of the U-shaped clamping piece is the non-abutting part.

3. The folding mechanism according to claim 2, wherein the folding mechanism further comprises a screw rod and a knob, and the first folding body has a connecting part; and
the screw rod has an end connected to the connecting part in a threaded manner and an end penetrating through the U-shaped clamping piece to be fixedly connected to the knob.

4. The folding mechanism according to claim 2, wherein the folding mechanism further comprises a screw rod and a knob, and the first folding body has a connecting part; and
the screw rod has an end fixedly connected to the connecting part and an end penetrating through the U-shaped clamping piece to be connected to the knob in a threaded manner.

5. The folding mechanism according to claim 3, wherein an elastic gasket is arranged between the knob and the U-shaped clamping piece.

6. The folding mechanism according to claim 4, wherein an elastic gasket is arranged between the knob and the U-shaped clamping piece.

7. The folding mechanism according to claim 3, wherein inner sides of the two ends of the U-shaped clamping piece gradually expand outwards towards an opening of the U-shaped clamping piece, the first clamping groove has a first oblique plane, the second clamping groove has a second oblique plane, the inner side of one said end of the U-shaped clamping groove is attached to the first oblique plane, and the inner side of the other end of the U-shaped clamping piece is attached to the second oblique plane.

8. The folding mechanism according to claim 4, wherein inner sides of the two ends of the U-shaped clamping piece gradually expand outwards towards an opening of the U-shaped clamping piece, the first clamping groove has a first oblique plane, the second clamping groove has a second oblique plane, the inner side of one said end of the U-shaped clamping groove is attached to the first oblique plane, and the inner side of the other end of the U-shaped clamping piece is attached to the second oblique plane.

9. The folding mechanism according to claim 3, wherein the first clamping groove and the second clamping groove are axially symmetric with each other when the first folding body and the second folding body are unfolded, the screw rod and the connecting part are located between the first clamping groove and the second clamping groove, and the screw rod penetrates through a center of the U-shaped clamping piece to be connected to a center of the knob.

10. The folding mechanism according to claim 4, wherein the first clamping groove and the second clamping groove are axially symmetric with each other when the first folding body and the second folding body are unfolded, the screw rod and the connecting part are located between the first clamping groove and the second clamping groove, and the screw rod penetrates through a center of the U-shaped clamping piece to be connected to a center of the knob.

11. The folding mechanism according to claim 3, wherein a U-shaped folding surface towards the U-shaped clamping piece is formed when the first folding body and the second folding body are unfolded; and
a gap is formed between the bottom side of the U-shaped clamping piece and the folding surface when the first folding body and the second folding body are unfolded.

12. The folding mechanism according to claim 4, wherein a U-shaped folding surface towards the U-shaped clamping piece is formed when the first folding body and the second folding body are unfolded; and
a gap is formed between the bottom side of the U-shaped clamping piece and the folding surface when the first folding body and the second folding body are unfolded.

13. The folding mechanism according to claim 3, wherein a limit ring is arranged on the screw rod, and the U-shaped clamping piece has a fixing hole allowing the screw rod to penetrate through; and
an outer diameter of the limit ring is greater than a diameter of the fixing hole, and the U-shaped clamping piece is clamped between the limit ring and the knob.

14. The folding mechanism according to claim 1, wherein the first folding body is a folding saddle locked on a frame of an electrical scooter with a bolt, the second folding body is a folding cover fixed to a vertical bar of the electrical scooter, and the folding saddle and the folding cover rotate upwards or downwards by means of a folding pin to form a hinge structure.

15. The folding mechanism according to claim 2, wherein the first folding body is a folding saddle locked on a frame of an electrical scooter with a bolt, the second folding body is a folding cover fixed to a vertical bar of the electrical scooter, and the folding saddle and the folding cover rotate upwards or downwards by means of a folding pin to form a hinge structure.

16. The folding mechanism according to claim 3, wherein the first folding body is a folding saddle locked on a frame of an electrical scooter with a bolt, the second folding body is a folding cover fixed to a vertical bar of the electrical scooter, and the folding saddle and the folding cover rotate upwards or downwards by means of a folding pin to form a hinge structure.

17. The folding mechanism according to claim 4, wherein the first folding body is a folding saddle locked on a frame of an electrical scooter with a bolt, the second folding body is a folding cover fixed to a vertical bar of the electrical scooter, and the folding saddle and the folding cover rotate upwards or downwards by means of a folding pin to form a hinge structure.
